(19) United States
(12) Patent Application Publication
(10) Pub. No.: US 2016/0255559 A1
(43) Pub. Date: Sep. 1, 2016

(54) SELECTING A RADIO ACCESS TECHNOLOGY AT A WIRELESS DEVICE

(71) Applicant: General Motors LLC, Detroit, MI (US)

(72) Inventors: Scott T. Droste, Ferndale, MI (US); David George, Farmington Hills, MI (US)

(21) Appl. No.: 14/632,823

(22) Filed: Feb. 26, 2015

(51) Int. Cl. H04W 36/16; H04W 64/00; H04W 48/16

(52) U.S. Cl. CPC H04W 36/165; H04W 48/16; H04W 64/006; H04W 88/06

(57) ABSTRACT

A system and method of selecting a radio access technology (RAT) at a wireless device includes: establishing an active packet data session from the wireless device through a cellular base station using a 3G RAT; detecting a trigger at the wireless device; searching for another cellular base station that uses a 4G long term evolution (LTE) RAT in response to the trigger; buffering data from the active packet data session that is directed from the wireless device to the cellular base station using the 3G RAT in memory while the wireless device attempts a cellular connection with the cellular base station using 4G LTE; establishing the active packet data session with the cellular base station using 4G LTE; and transmitting the buffered data to the cellular base station using 4G LTE

### TECHNICAL FIELD

The present invention relates to wireless communications and, more particularly to selecting radio access technologies (RATs) at a wireless device.

### BACKGROUND

Modern wireless devices can communicate using a variety of different cellular communications protocols or RATs. These types of wireless devices can be referred to as multi-band devices. As wireless devices move, some cellular base stations used by the devices may facilitate communications via a 3G RAT while other cellular base stations may do so using a 4G Long Term Evolution (LTE) RAT. Sometimes, a wireless device may be simultaneously within communication range of cellular base stations using a 3G RAT as well as other cellular base stations communicating using a 4G LTE RAT. Under those circumstances, the wireless device may be communicating data using the 3G RAT but would be able to transmit data more quickly by switching to a cellular base station operating using 4G LTE. Despite having an option to access the 4G LTE base station, wireless devices tend to continue communicating via 3G RAT cellular base stations.

### SUMMARY

According to an embodiment of the invention, there is provided a method of selecting a RAT at a wireless device. The method includes establishing an active packet data session from the wireless device through a cellular base station using a 3G RAT; detecting a trigger at the wireless device; searching for another cellular base station that uses a 4G LTE RAT in response to the trigger; buffering data from the active packet data session that is directed from the wireless device to the cellular base station using the 3G RAT in memory while the wireless device attempts a cellular connection with the cellular base station using 4G LTE; establishing the active packet data session with the cellular base station using 4G LTE; and transmitting the buffered data to the cellular base station using 4G LTE.

According to another embodiment of the invention, there is provided a method of selecting a RAT at a wireless device. The method includes establishing an active packet data session from the wireless device through a cellular base station using a 4G LTE RAT; determining that the active packet data session is transmitted through a cellular base station using a 3G RAT; detecting a trigger at the wireless device; searching for another cellular base station that uses a 4G LTE RAT in response to the trigger; buffering data from the active packet data session that is directed from the wireless device to the cellular base station using the 3G RAT in memory while the wireless device attempts a cellular connection with the cellular base station using 4G LTE; establishing the active packet data session with the cellular base station using 4G LTE; and transmitting the buffered data to the cellular base station using 4G LTE.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein; and

FIG. 2 is a flow chart depicting an embodiment of a method of selecting a RAT at a wireless device;

FIG. 3 is a graph depicting a wireless device in different operational states; and

FIG. 4 is a block diagram depicting an embodiment of an environment in which the wireless device can switch between a 3G RAT and a 4G LTE RAT.

### DETAILED DESCRIPTION OF THE ILLUSTRATED EMBODIMENTS

The system and method described below directs wireless devices with active data sessions using a 3G radio access technology (RAT) to attempt transferring those data sessions to base stations using 4G LTE. As cellular wireless carrier systems evolved and began using cellular base stations that used 4G LTE as well as 3G LTE, the systems have permitted wireless devices to transfer active packet data sessions from base stations that use 4G LTE to base stations that use 3G when the 4G LTE base station is no longer available. An active packet data session generally refers to a wireless device that is not in an idle mode but is actively transmitting packets of data. If a wireless device moves from an area serviced by base stations using 4G LTE to an area where only 3G is available, the wireless carrier system ensures that the active packet data session remains operational.

Yet the transition from 4G LTE to 3G can reduce the data speeds and/or increase the latency when compared to using 4G LTE. Reduced data speeds may not affect some software applications when operating alone, such as those streaming audio. But the wireless device may be used as a wireless hotspot that provides Internet access to other nearby wireless devices. As nearby wireless devices access the wireless hotspot while other software applications are running, the data throughput can increase such that latencies are noticeable at the software application on the wireless device, the nearby wireless devices, or both.

While the wireless carrier systems permit transfer from base stations using a 4G LTE RAT to those using 3G, the wireless carrier systems do not permit or support transferring active packet data sessions from base stations using 3G to base stations using 4G LTE. As the user moves the wireless device into an area where 4G LTE is available along with 3G (or returns to the 4G LTE area where 3G is also available), the user may notice that other wireless devices not actively transmitting data may switch to the 4G LTE cellular base station while the wireless device actively transmitting data may appear “stuck” using a 3G base station. In this case, the user may incorrectly believe that the wireless device continuing to actively transmit data via the 3G base station is malfunctioning.

To transition the wireless device engaged in an active packet data session using a 3G cellular base station to a 4G LTE cellular base station, the wireless device can monitor for a triggering event that causes the device to look for 4G LTE service. These triggering events can include detecting the geographic location of known 4G LTE service, a periodic timer, or other mechanism for initiating the wireless device to search for or attempt connection to a 4G LTE cellular base station. The triggering event can cause the wireless device to stop transmitting data to the 3G cellular base station and store data generated by the active packet data session for uplink in a buffer at the wireless device. Once the wireless device has identified a cellular base station providing service via 4G LTE, the device can establish a wireless data connection with the 4G LIE base station, transmit the buffered data to the 4G LTE base station, and continue the active packet data session via the 4G LTE base station. The system and method will be described below in terms of a vehicle telematics unit, an audio system that includes an infotainment head unit (IHU), or both. But it should be appreciated that the method discussed herein can be applied to other wireless devices that have the capability to communicate using cellular protocols.

### Communications System—

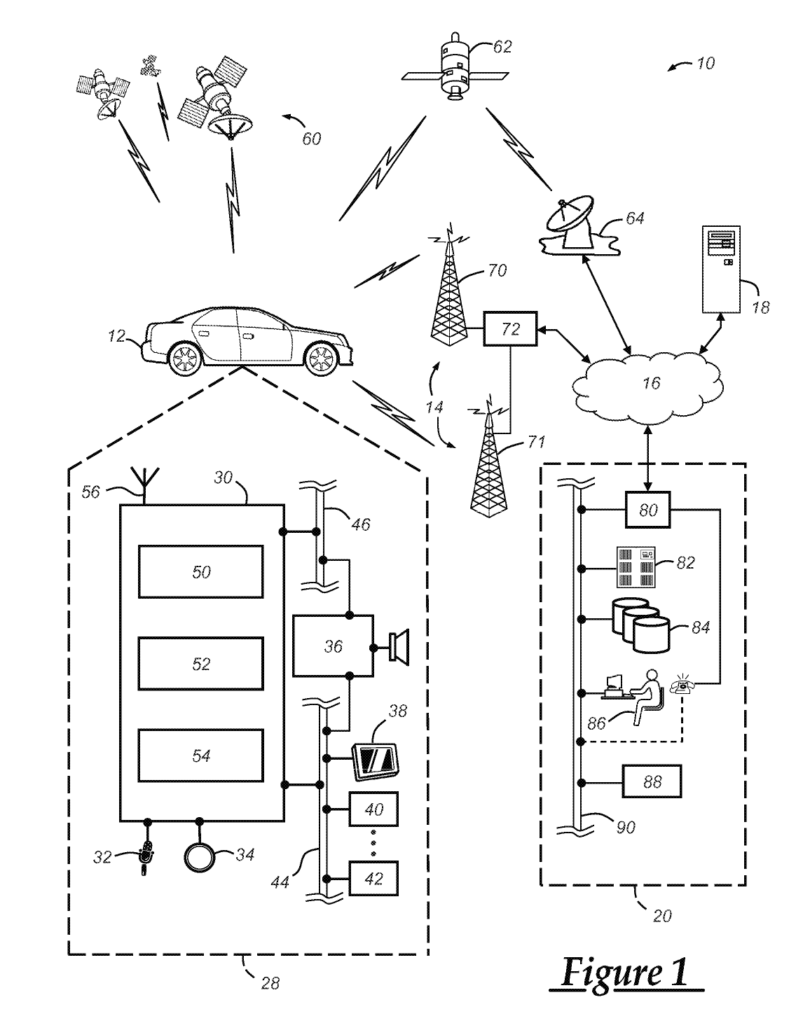

With reference to FIG. 1, there is shown an operating environment that comprises a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well,

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that is installed in the vehicle and that enables wireless voice and/or data communication over wireless carrier system 14 and via wireless networking. This enables the vehicle to communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art,

According to one embodiment, telematics unit 30 utilizes cellular communication according to either 3G GSM/CDMA, or 4G Long Term Evolution (LTE) standards (defined by the third generation partnership project (3GPP) and 3GPP2) and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as LTE, EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, including short range wireless communications (SRWC) such as any of the IEEE 80211 protocols, WiMAX, ZigBee™, Wi-Fi direct, Bluetooth, or near field communication (NFC). When used for packet-switched data communication such as TCP/IP, the telematics unit can be configured with a static IP address or can set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites.

From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible,

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. The audio system 36 can also be referred to as an infotainment head unit and include short-range wireless communications capabilities. In one implementation, the infotainment head unit can store one or more software applications related to the access and delivery of streaming audio from a remote source via the wireless carrier system 14. Examples of services that provide streaming audio include Pandora and Spotify each of which provide software applications that are stored at the audio system 36 or elsewhere at the vehicle 12 and accessed by a vehicle occupant to select and play audio in the vehicle 12. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 and 71 (also referred to as cellular base stations), one or more mobile switching centers (MSCs) 72, as well as any other networking components required to connect wireless carrier system 114 with land network 16. Each cell tower 70 and 71 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as 3G CDMA CDMA2000, HSPA+), GSM/GPRS as well as 4G LTE. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can he done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. directional communication can be, for example, satellite telephony services using satellite 62 to relay telephone communications between the vehicle 12 and station 64. If used, this satellite telephony can be utilized either in addition to or in lieu of wireless carrier system 14.

Land network. 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modern (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

### Method—

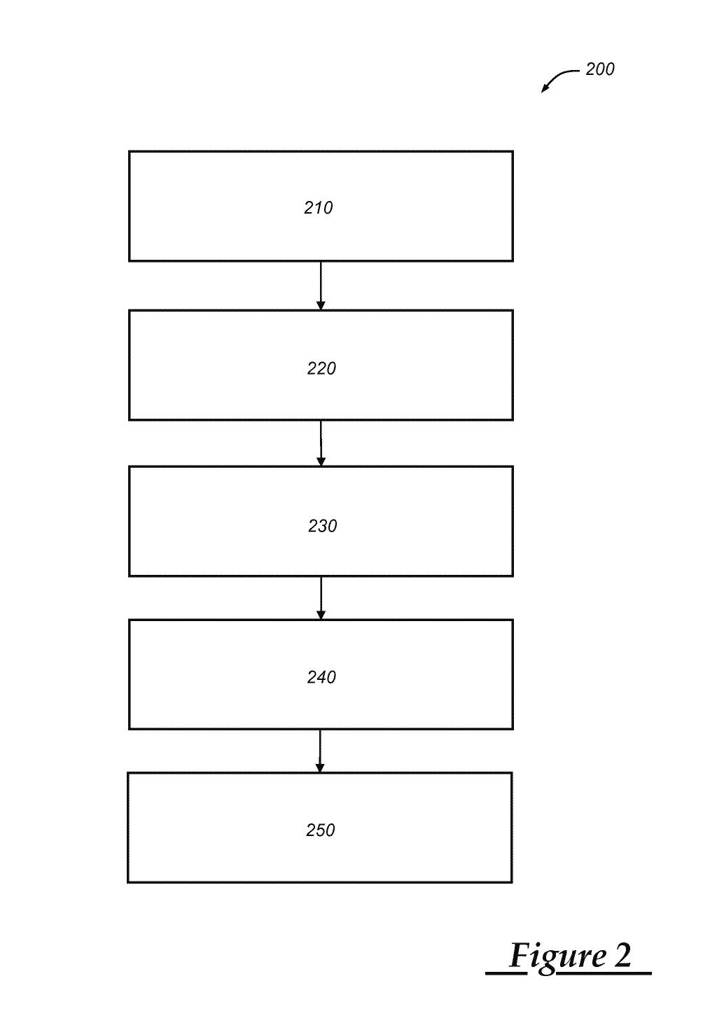

Turning now to FIG. 2, there is shown a method (200) of selecting a radio access technology (RAT) at a wireless device. In this implementation, the wireless device will be described in terms of the vehicle telematics unit 30. The method 200 begins at step 210 by establishing an active packet data session from the vehicle telematics unit 30 through a cellular base station, such as cell towers 70 or 71, using a 4G LTE RAT. Packet data sessions can be established for a variety of purposes. For instance, the vehicle 12 can initiate a vehicle data upload to a central facility, such as the computer 18 or call center 20. Or in another example, a vehicle occupant can stream audio from the Internet to the audio system 36 through the wireless carrier system 14. At the same time, the vehicle telematics unit 30 or the audio system 36 can act as a wireless hotspot through which other wireless devices, such as vehicle telematics units, can access the Internet.

As the vehicle 12 moves, the vehicle telematics unit 30 may be in a geographical area that is serviced by cell towers 70 and 71 that facilitate communications using one type of RAT, such as 4G LTE and 3G, respectively. If given the choice between cell towers using 3G or 4G LTE, the vehicle telematics unit 30 is generally programmed to prefer using 4G LTE because it offers higher data speeds than are possible with the 3G RAT. Cell tower 70 provides cellular service via a 4G LTE RAT and can be located within a geographic area that also includes cell tower 71 providing service via 3G. When the vehicle 12 is located in an area where 4G LTE is available and a vehicle occupant or vehicle 12 initiates the software application or an upload of packetized data, the vehicle telematics unit 30 can select the cell tower 70 that provides cellular service via 4G LTE. The method 200 proceeds to step 220.

At step 220, it is deter that the active packet data session begins transmission through a cellular base station using a 3G RAT. When the vehicle 12 moves away from or out of the area where the cell tower 70 provides wireless service via 4G LTE, the vehicle telematics unit 30 can complete a packet-switched hand off (PSHO) that seamlessly transfers the active packet data session from cell tower 70 providing wireless service via 40 LTE to cell tower 71 providing cellular service via 3G. Transferring the active packet data session from 4G LTE to 3G can occur automatically without interruption in the data flow.

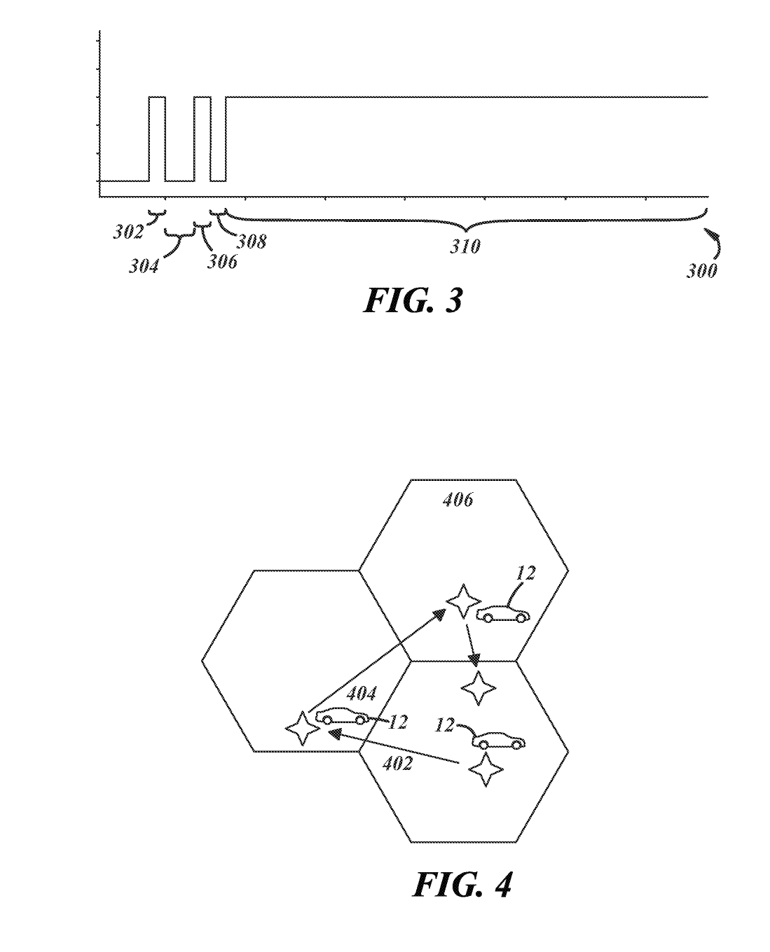

When the packet data session is active, the vehicle telematics unit 30 is transmitting data such that the radio resource control (RRC) state of the unit 30 is in a connected mode for extended periods of time. An example of this is shown in FIG. 3 as a graph depicting the changing state of the RRC between idle and active while an audio streaming software application is running In this implementation, the audio system 36 can run an audio streaming software application that communicates packet data over the entertainment bus 46 via the vehicle telematics unit 30. During an initial state, the RRC of the vehicle telematics unit 30 is idle. As the vehicle occupant initiates the software application, the vehicle telematics unit 30 can transmit packet data to the cell tower 70 and the RRC becomes active. This is shown as 302 in FIG. 3. After initiating the software application, the RRC can enter an idle state shown at 304 until the vehicle occupant selects the music to be played at 306. The packet data session becomes idle again (308) until the music is received as streamed packet data (310). When the software application streams music as packetized data, the vehicle telematics unit 30 maintains the packet data session in an active state e.g., the RRC is in a connected mode) for an extended period. The RRC idle mode can permit the vehicle telematics unit 30 to change the RAT it presently uses by selecting a different cell tower. But when the vehicle telematics unit 30 is transmitting data so that the RRC is in an active mode, the unit 30 cannot switch from a 3G RAT to a 4G LTE RAT. The method 200 proceeds to step 230.

At step 230, a trigger is detected at the vehicle 12 that causes the vehicle telematics unit 30 to search for another cellular base station using a 4G LTE RAT. While the vehicle telematics unit 30 maintains an active packet data connection, a number of different triggers can cause the vehicle telematics unit 30 to begin a search to locate a cellular base station that provides service via 4G LIE, such as cell tower 70. In one example, the vehicle telematics unit 30 can record location data using the GPS unit 40 when the unit detects 4G LTE cellular service. Later, the vehicle telematics unit 30 can compare its current location with previously-recorded location data that reflects where 4G LTE service was available in the past. In this case, the trigger can be a match between the current location of the vehicle 12 and a previously-stored location where 4G LTE service has been available. Other types of triggers can be used to initiate the vehicle telematics unit 30 to search for 4G LIE service while the vehicle telematics unit 30 maintains an active packet data session_{—} with a 3G cell tower. For example, the vehicle telematics unit can execute a combined tracking area update procedure while communicating with the cell tower 70 using 4G LTE. This procedure is explained in more detail in 3GPP TS 24.301. When successful, the vehicle telematics unit 30 can record a location area code (LAC) received from the wireless carrier system 14 as part of the procedure. The recorded LAC can identify 4G LTE service. When using 3G, the vehicle telematics unit 30 can detect a broadcast LAC and determine if it indicates that 4G LTE service is available. The vehicle telematics unit 30 can detect a LAC as part of a location update procedure described in 3GPP TS 24.008.

Another example of the trigger involves the vehicle telematics unit 30 using a timer to periodically cause the unit 30 to search for 4G LTE service after a predetermined amount of time has passed. Once the vehicle telematics unit 30 stops using 4G LTE and begins using 3G, the vehicle telematics unit 30 can initialize a timer having a time limit. Once the time limit expires, the vehicle telematics unit 30 can begin a search for 4G LTE service. If the vehicle telematics unit 30 locates a cell tower 70 providing 4G LIE service, the method proceeds to step 240. Otherwise, the timer is reset and initialized with the time limit. The time limit can be static/fixed or it can be dynamic. In an implementation where the time limit is dynamic, an amount of time can be added to the time limit based on an increasing function of the number of times the vehicle searches for 4G LTE service multiplied by an amount of time. And the number of times the vehicle telematics unit 30 searches for 4G LTE service can be capped at a maximum value. This relationships is shown below where Tₛₑᵢ equals the static time limit, F(n) is an increasing function of n (the number of times the vehicle telematics unit 30 searches for 4G TE service), and Tₘₐₓ is the maximum amount of time the vehicle telematics unit 30 can search for 4G LTE service. T_{inc} reflects the amount of time can be added to the time limit.

Tₛₑᵢ(n)=Tₛₑᵢ+F(n)T_{inc} Tₛₑᵢ(n)≦Tₘₐₓ

Triggers also can be implemented based on a distance the vehicle 12 travels, For example, the vehicle telematics unit 30 can measure the distance that has passed since the most-recent contact with a cell tower 70 providing service via a 4G LTE RAT. After beginning transmission of the active packet data session through a cellular base station using a 3G RAT (e.g. cell tower 71), the vehicle telematics unit 30 can determine the location of the vehicle 12 using the GPS module 40. The vehicle telematics unit 30 can monitor the distance the vehicle 12 has travelled since using 4G LTE. Once a distance limit has been reached, the vehicle telematics unit 30 can attempt to locate a cell tower 70 that provides 4G LTE. The distance limit can be static/fixed or dynamic and can be implemented in a similar way to the tinier discussed above. The method 200 proceeds to step 240.

At step 240, data is buffered from the active packet data session that is directed from the vehicle telematics unit 30 to the cellular base station using the 3G RAT while the unit 30 attempts a cellular connection with the cellular base station using 4G LTE. After the vehicle telematics unit 30 has been triggered to search for the 4G LTE RAT, the unit 30 can block all transmission of uplink non-access stratum (NAS) signaling over the active packet data session to the cell tower 71 providing service via 3G. This uplink NAS signaling is described in more detail in 3GPP TS 24.008. The data packets that continue to be generated by the active packet data session can be temporarily stored in a buffer. A memory device, such as a portion of vehicle memory 54, can be dedicated to the buffer. These data packets can then be wirelessly transmitted after the vehicle telematics unit 30 has either successfully established for re-established) wireless communications with the cell tower 70 or has determined that 4G LTE service is not available and continued the active packet data session on the cellular base station using the 3G RAT (e.g., cell tower 71). The method 200 proceeds to step 250.

At step 250, the active packet data session is established with the cellular base station using 4G LTE when the vehicle telematics unit 30 is able to detect and establish communications with the cell tower 70 that provides 4G LTE service. Otherwise, the vehicle telematics unit 30 re-establishes the active packet data session with the cell tower 71 providing 3G service. When the vehicle telematics unit 30 has successfully detected 4G LTE service, the unit 30 can transmit a packet switch domain signaling connection release indication message to the cell tower 71. The cell tower 71 can respond to the vehicle telematics unit 30 with an RRC connection release message and the unit 30 can generate a confirmation by transmitting an RRC connection release complete message to the cell tower 71. The vehicle telematics unit 30 can end communications with the cell tower 71 and establish the active packet data communication data session with cell tower 70. The buffered data can then be transmitted using 4G LTE via the cell tower 70 and the active packet data communication session can be continued. The method 200 then ends.

FIG. 4 depicts a system 400 in which the method described above can be implemented. Specifically, the system 400 depicts an implementation in which a vehicle 12 moves through a plurality of different cellular service areas each of which has a different LAC. The vehicle 12 may begin in cellular service area 402 that includes a plurality of cell towers, some of which provide service using a 3G RAT while others use 4G LTE. While in cellular service area 402, the vehicle telematics unit 30 may establish an active packet data session using 4G LTE. The vehicle telematics unit 30 can also record the LAC it detects in cellular service area 402. The vehicle 12 can then leave the cellular service area 402 and cross into cellular service area 404. There, the vehicle telematics unit 30 can detect that only 3G service is available from cell towers by determining that the LAC broadcast does not match a previously-stored LAC that would indicate that the area 404 provided 4G LTE service. The vehicle 12 can then move to another cellular service area 406 and determine that only 3G service is available in the same way as carried out when the vehicle 12 moved from area 402 to area 404. Once the vehicle 12 travels from cellular area 404 to cellular area 402, the vehicle telematics unit 30 can detect that it has previously used 4G LTE service in the cellular area 402 based on the LAC detected in the area 402. The vehicle telematics unit 30 can then be triggered to attempt to connect with a base station providing 4G LTE service.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of selecting a radio access technology (RAT) at a wireless device, comprising the steps of:
(a) establishing an active packet data session from the wireless device through a cellular base station using a 3G RAT;
(b) detecting a trigger at the wireless device;
(c) searching for another cellular base station that uses a 4G long term evolution (LTE) RAT in response to the trigger;
(d) buffering data from the active packet data session that is directed from the wireless device to the cellular base station using the 3G RAT in memory while the wireless device attempts a cellular connection with the cellular base station using 4G LIE;
(e) establishing the active packet data session with the cellular base station using 4G LTE; and
(f) transmitting the buffered data to the cellular base station using 4G LTE.

2. The method of claim 1, further comprising the steps of recording location data at the wireless device when connected to a cellular base station using 4G LTE and later comparing a current location of the wireless device with the recorded location data.

3. The method of claim 1, wherein the trigger further comprises detecting a location area code (LAC) indicating available 4G LTE service.

4. The method of claim 1, wherein the trigger further comprises a timer that periodically reaches a static time limit.

5. The method of claim 1, wherein the trigger further comprises a timer that periodically reaches a dynamic time limit.

6. The method of claim 1, wherein the wireless device further comprises a vehicle telematics unit.

7. The method of claim 1, wherein data from the active packet data session is received by an audio streaming software application.

8. The method of claim 1, wherein the wireless device provides a wireless hotspot that allows other wireless devices to access the Internet via short-range wireless communication protocols.

9. The method of claim 1, further comprising the step of establishing the active packet data session with a cellular base station using a 4G LTE before step (a).

10. A method of selecting a radio access technology (RAT) at a wireless device, comprising the steps of:
(a) establishing an active packet data session from the wireless device through a cellular base station using a 4G long term evolution (LTE) RAT;
(b) determining that the active packet data session is transmitted through a cellular base station using a 3G RAT;
(c) detecting a trigger at the wireless device;
(d) searching for another cellular base station that uses a 4G LTE RAT in response to the trigger;
(e) buffering data from the active packet data session that is directed from the wireless device to the cellular base station using the 3G RAT in memory while the wireless device attempts a cellular connection with the cellular base station using 4G LTE;
(f) establishing the active packet data session with the cellular base station using 4G LTE; and
(g) transmitting the buffered data to the cellular base station using 4G LTE.

11. The method of claim 10, further comprising the steps of recording location data at the wireless device when connected to the cellular base station using 4G LTE and later comparing a current location of the wireless device with the recorded location data.

12. The method of claim 10, wherein the trigger further comprises detecting a location area code (LAC) indicating available 4G LTE service.

13. The method of claim 110, wherein the trigger further comprises a timer that periodically reaches a static time limit.

14. The method of claim 10, wherein the trigger further comprises a timer that periodically reaches a dynamic time limit.

15. The method of claim 10, wherein the wireless device further comprises a vehicle telematics unit.

16. The method of claim 10, wherein data from the active packet data session is received by an audio streaming software application.

17. The method of claim 10, wherein the wireless device provides a wireless hotspot that allows other wireless devices to access the Internet via short-range wireless communication protocols.
